(19) United States
(12) Patent Application Publication
(10) Pub. No.: US 2008/0192475 A1
(43) Pub. Date: Aug. 14, 2008

(54) Illumination Device for Producing Light Effects As Well As Insert for Such an Illumination Device

(75) Inventor: Markus Salm, Heusweiler (DE)

Correspondence Address: SCHOPPE, ZIMMERMAN , STOCKELLER & ZINKLER, C/O KEATING & BENNETT , LLP, 8180 GREENSBORO DRIVE , SUITE 850, MCLEAN, VA, 22102, US

(73) Assignee: GLP GERMAN LIGHT PRODUCTS GMBH, Karlsbad (DE)

(21) Appl. No.: 11/995,858

(22) PCT Filed: Jul. 27, 2006
(86) PCT No.: PCT/EP2006/007421

§ 371 Date: Feb. 8, 2008

(30) Foreign Application Priority Data
Aug. 1, 2005 (DE) 20 2005 012 070.7

(51) Int. Cl. F21S 8/00

(52) U.S. Cl. 362/277

(57) ABSTRACT

An illumination device for producing light effects has a housing with at least one light source. At least one effect element, which subjects a light beam coming from the light source to optical effects, can be received in the housing. By at least the effect element being receivable in a frame, which can be inserted into the self-supporting housing as an insert, at least one effect element is arranged in the illumination device in protected manner such that it is nevertheless well accessible, if necessary. The insert may also be used separately.

### CROSS-REFERENCE TO RELATED APPLICATIONS

The present invention claims the priority of German patent application 20 2005 012 070.7, filed Aug. 1, 2005, the disclosure of which herewith is expressly also made the subject matter of the present application.

### TECHNICAL FIELD

The invention relates to an illumination device for producing light effects by a light source received in a housing, using effect elements according to the preamble of claim 1, as well as an insert for such an illumination device according to the preamble of claim 11.

### BACKGROUND

Common projectors for stage or theatre illumination, for architectural illumination and the like include means for releasably inserting various kinds of effect elements for influencing the optical light beam generated by a light source. To this end, various effect elements are brought into the light beam of the light source, in order to vary color, intensity, size, shape and pattern of the light beam. For example, a light source may generate white light, which is subjected to at least one color filter wheel for generating a colored light beam, a gobo wheel for generating a selected pattern on the light beam, and a light intensity wheel for changing the intensity of the light sent out, for example. There may also be provided a mechanical iris for determining the beam size and a lens system for regulating the focus and the divergence of the light beam. Similar systems of this kind are known from U.S. Pat. No. 4,392,187, for example.

From U.S. Pat. No. 4,460,943, a mounting plate with a plurality of equally spaced openings arranged around a common axis for mounting gobos within one or more of the openings is known. For example, the plate is driven rotatably about its axis by means of a motor, in order to bring a selected gobo into the light beam. A similar arrangement is known from U.S. Pat. No. 4,891,738.

Such illumination devices are rotated via various drives such that the generated light beam can be moved as freely as possible in space. For this reason, these illumination devices are constructed in compact manner to keep the inertia forces of the projector as small as possible even at higher speeds. This compact design therefore regularly complicates the exchange of gobos and other effect elements in the illumination device.

From U.S. Pat. No. 6,601,973 B2 underlying the preamble of the independent claims, forming a gobo carousel to be compact is therefore already known, wherein various gobo wheels are positively driven via a toothed central sun wheel. Thereby, the gobos in the carousel can be exchanged easily. Exchange within the illumination device, however, is not possible easily therewith. Such an exchange or access is, however, necessary regularly to service and to clean gobo wheels, if necessary.

Furthermore, arranging various control elements on inserts that are releasable from the illumination device, if necessary, is also known, as is also true for the plugin cards on computers in a similar manner.

### SUMMARY

According to an embodiment, an illumination device for producing light effects may have: a housing, at least one light source, at least one effect element receivable in the housing, which subjects a light beam coming from the light source to optical effects, wherein at least the effect element can be received in a three-dimensional frame insertable as an insert into the self-supporting housing, wherein the frame includes several parts movable with respect to each other, which are connected to each other in a hinge-like or slideable manner and formed such that they enclose the effect element in the usage state, so that the effect element is arranged inside the three-dimensional frame, and which are movable with respect to each other in hinge-like or slideable manner when out of use so that the effect element arranged inside the frame is freely accessible.

According to another embodiment, an insert for sliding into the housing of an illumination device for producing light effects with at least one effect element, which produces optical effects, using a light beam coming from a light source, may have a frame receiving therein at least the effect element, wherein the frame includes several parts movable with respect to each other, which are connected to each other in a hinge-like or slideable manner and formed such that they enclose the effect element in the usage state, so that the effect element is arranged inside the three-dimensional frame, and which are movable with respect to each other in hinge-like or slideable manner when out of use so that the effect element arranged inside the frame is freely accessible.

To this end, the effect element can be received in a frame formed as an insert for sliding the illumination device in. Thus, the effect elements can be taken out from the illumination device, if necessary, to be able to subject same to maintenance. The sensitive effect elements are protected in the frame, but the frame can be supplied as a distinct element of the illumination device. This enables the manufacturer to prefabricate the entire insert in the factory and check same for functionality as a distinct element or, for example, ship same as a spare part, if necessary. Hence, the disadvantage that the support elements usually holding the effect elements, such as filters, gobo wheels and the like, can be removed from the housing, which necessitates forming the housing of the illumination device to be more stable and self-supporting, is deliberately accepted. This advantage is by far offset again by the advantages gained therewith of good accessibility of the effect elements.

Advantageously, the frame is provided with all units necessary for operation of the effect elements, so that, after inserting the insert into the housing, only the current supply and, if necessary, the handover of control signals must be ensured to reliably bring the light effects into the light beam in controlled manner.

Furthermore, the parts of the frame are connected to each other in a hinge-like or slideable manner, so that the effect elements arranged in the frame become accessible by folding open or shifting such that they are easy to clean, service or replace. If necessary, another insert can be inserted into the illumination device during this time, so that same can be operated further.

### BRIEF DESCRIPTION OF THE DRAWINGS

Embodiments of the present invention will be detailed subsequently referring to the appended drawings, in which:

FIG. 1 shows an illumination device with removed lid and inserted insert,

FIG. 2 is an illustration according to FIG. 1 with an insert removed from the illumination device,

FIG. 3 is a three-dimensional illustration of the insert in an assembled state,

FIG. 4 is an illustration of the insert when it is folded open, with a view on the effect elements,

FIG. 5 shows the folded-open frame of the insert.

### DETAILED DESCRIPTION

The invention will now be exemplarily explained in greater detail with reference to the attached drawings. The embodiments, however, are only examples not meant to limit the inventive concept to a certain arrangement.

Before describing the invention in detail, it is to be pointed out that same is not limited to the respective components of the device as well as the respective method steps, since these components and methods may vary. The terms used here are only intended for describing particular embodiments and are not used in a limiting manner. Moreover, if the singular or indefinite articles are used in the description or in the claims, this also refers to the plurality of these elements, unless the overall context clearly dictates otherwise.

The figures show an illumination device for producing light effects having a housing 10, in which at least one light source, not shown in drawing, is provided. In the housing 10, at least one effect element 11,12,13 is received subjecting a light beam coming from the light source to optical effects, to thereby achieve special light effects. The effect elements can be driven by means of at least one motor drive 14,15,16. Such illumination devices are used in the form of “moving heads” for stage or theatre illumination or also for architectural lighting, for example. In stage and theatre illumination, in particular, such illumination means are often arranged rotatably about various axes, so that a compact construction basically is desired.

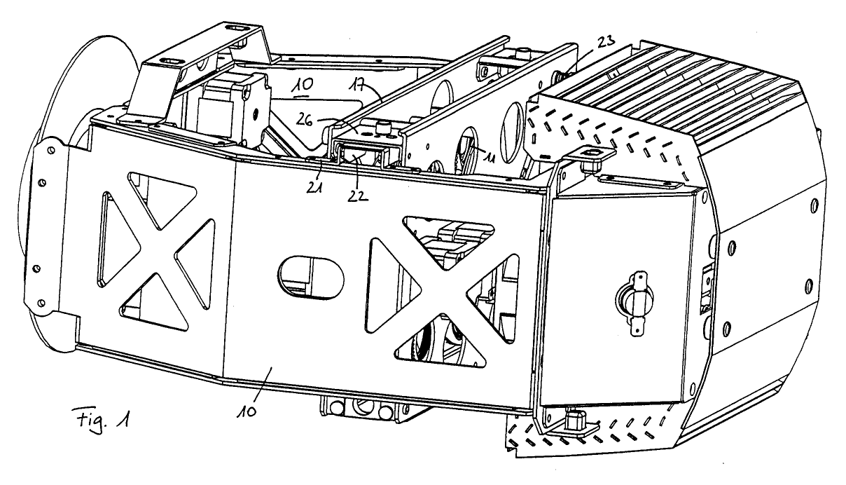

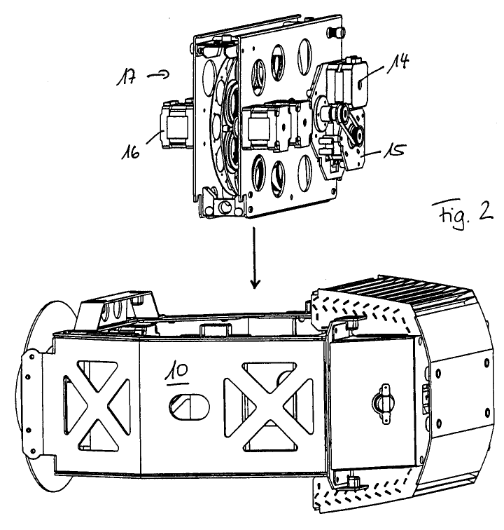

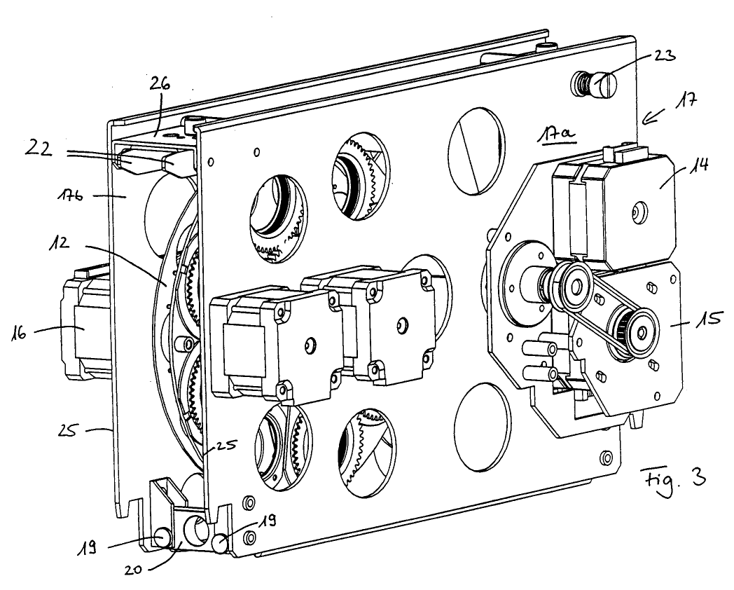

It can be taken from FIGS. 1 and 2, in particular, that at least the at least one effect element 11,12,13 can be received in a frame 17, which can be inserted as an insert into the self-supporting housing 10 of the illumination device. According to FIGS. 3 to 5, the effect element 11,12,13 is arranged internally in the three-dimensional frame 17, whereas the motor drives 14,15,16 are arranged externally on the parts 17a,17b of the frame 17. Thereby, the effect elements, for example gobo wheels or filters, are protected as far as possible within the support plates of the frame.

Apart from the effect element 11,12,13, the motor drive 14,15,16 and also associated control elements, not illustrated in drawing, are associated with the frame, so that the frame, together with its parts, forms a structural unit that can be supplied to the illumination device by itself and only still needs to be provided with a current supply and the corresponding control signals to enable operation of the effect elements. At the same time, this means that the insert thus formed can be checked for its functionality by itself independently of the rest of the illumination device at the manufacturer's. Thereby, it is possible to replace the insert by itself, to ship same even to remote countries as a spare part, or ensure the further operation of the illumination device by the mere replacement thereof.

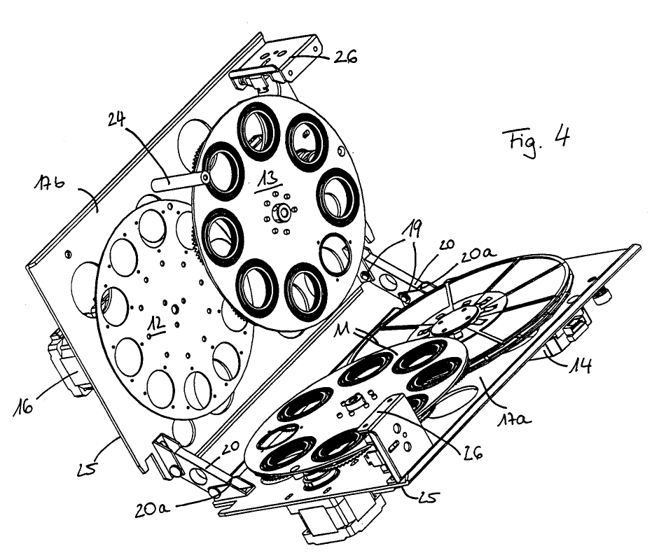

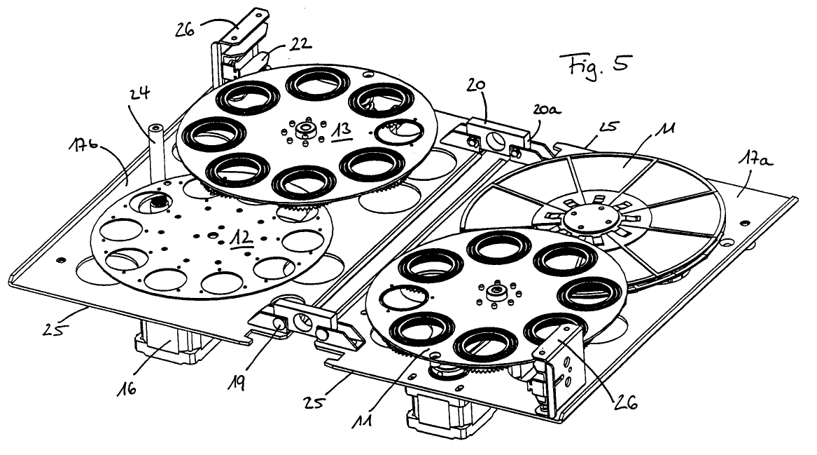

The frame 17 itself comprises several parts 17a,17b movable with respect to each other, which enclose the effect element 11,12,13 in the usage state and are movable with respect to each other when out of use such that the effect elements arranged inside the frame 17 become freely accessible according to FIGS. 4 and 5. While the motor drives 14,15,16 are arranged externally on the frame 17, the parts of the frame 17 are connected to each other in a hinge-like manner via the hinge 19 in the embodiment for achieving easier accessibility. Basically, other ways of connection of the parts of the frame are also possible, for example by folding-open or by a slideable arrangement of the parts with respect to each other, wherein the part 17a in FIG. 3 is shifted to the right, for example, whereas the part 17b remains fixed, so that the accessibility of the internal parts of the frame 17 results.

On the other hand, by various elements it is ensured that the parts 17a,17b of the frame 17 can be positioned in a substantially axis-parallel manner in the usage state for forming at least one optical axis of the effect elements 11,12,13 received therein. According to FIGS. 4 and 5, to this end the hinge 19 itself comprises a spacer 20 bearing, with its faces 20a in the usage state of the insert in the illumination device, on the two support plates forming the parts 17a,17b of the frame 17 as a bearing surface. Furthermore, a spacer 24 is provided also securing and positioning the distance in the upper area. As a further element capable of securing axis parallelism, retaining elements 26 are provided for bolts 22 supposed to cause locking of the insert within the housing 10. These retaining elements 26 at the same time keep the parts 17a,17b at a distance once the fixing elements 23 according to FIG. 3 are tightened.

FIGS. 4 and 5 make clear how freely accessible the effect elements 11,12,13 are, which may, for example, be gobo wheels, filters and the like. In the embodiment, the effect element 12 is an effect wheel with stationary gobos, the effect element 13 comprises rotating gobos, and the effect element 11 comprises two gobo wheels inside each other. If necessary, further elements may be provided as far as it is only ensured that the corresponding motor drives are capable of driving the corresponding effect elements. Furthermore, it is also possible to provide further folding parts for receiving further effect elements externally to the frame 17, if necessary, not shown in drawing. These folding elements can be folded out on the frame 17 in the state removed from the illumination device.

So as to receive the frame with all its components in the self-supporting housing 10 of the illumination device, at first the frame comprises guide rails 25, along which it can be inserted into its position in the illumination device. These guide rails 25 cooperate with corresponding guiding elements of the housing 10. The guide rails 25 are conical at the bottom thereof, so that the insertion of the insert into the housing is facilitated. Toward the end of the insertion movement into the housing 10, the bolts 22, which are movably held at retaining elements 26 in spring-loaded manner, come into a locked position with the retaining part 21. Since the illumination device may regularly rotate mostly about several axes, fixing of the axially movably bolts may also be performed by the fixing element 23.

The insert may also be used as a distinct element.

It is obvious that the description can be subjected to the most diverse modifications, alterations and adaptations lying within the scope of equivalents to the appended claims.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1-20. (canceled)

21: An illumination device for producing light effects, comprising:
a housing,
at least one light source,
at least one effect element receivable in the housing, which subjects a light beam coming from the light source to optical effects,
wherein at least the effect element can be received in a three-dimensional frame insertable as an insert into the self-supporting housing,
wherein the frame includes several parts movable with respect to each other, which are connected to each other in a hinge-like or slideable manner and formed such that they enclose the effect element in the usage state, so that the effect element is arranged inside the three-dimensional frame, and which are movable with respect to each other in hinge-like or slideable manner when out of use so that the effect element arranged inside the frame is freely accessible.

22: The illumination device according to claim 21, wherein the effect element, at least one motor drive for operating the effect element, and associated control elements are associated with the frame, wherein the at least one motor drive for one or more effect elements arranged in the frame is arranged externally on the frame.

23: The illumination device according to claim 21, wherein, in the usage state, the parts of the frame can be positioned in a substantially axis-parallel manner for at least one common optical axis of the effect elements received therein.

24: The illumination device according to claim 21, wherein the frame comprises at least one hinge, and wherein the hinge comprises a spacer bearing, with its face in the usage state of the insert, on two support plates forming the parts of the frame as a bearing surface, and wherein furthermore a further spacer is provided to secure and position a distance of the two parts in the usage state of the insert.

25: The illumination device according to claim 24, wherein retaining elements and bolts held by the retaining elements are provided, which are formed to cause locking of the insert in the housing, wherein the retaining elements are further formed to keep the parts at a distance in the usage state.

26: The illumination device according to claim 25, wherein the bolts are movably held on the retaining elements in spring-loaded manner and formed to come to a locked position with a retaining part of the housing toward the end of an insertion movement of the frame into the housing.

27: The illumination device according to claim 25, wherein the bolts are movable axially, and wherein the frame further comprises a fixing element to fix the axially movable bolts.

28: The illumination device according to claim 21, wherein each part comprises a guide rail, which is formed to be inwardly conical at its end entering the housing first when the frame is inserted into the housing.

29: The illumination device according to claim 21, wherein further folding elements for receiving further effect elements or the like are provided on the frame, which elements can be folded out on the frame in the state removed from the illumination device.

30: The illumination device according to claim 21, wherein the at least one effect element includes gobo wheels with gobo holders.

31: An insert for sliding into the housing of an illumination device for producing light effects with at least one effect element, which produces optical effects, using a light beam coming from a light source, wherein the insert comprises a frame receiving therein at least the effect element,
wherein the frame includes several parts movable with respect to each other, which are connected to each other in a hinge-like or slideable manner and formed such that they enclose the effect element in the usage state, so that the effect element is arranged inside the three-dimensional frame, and which are movable with respect to each other in hinge-like or slideable manner when out of use so that the effect element arranged inside the frame is freely accessible.
